(19) United States
(12) Patent Application Publication
(10) Pub. No.: US 2009/0183995 A1
(43) Pub. Date: Jul. 23, 2009

(54) Ceramic material for use at elevated temperature

(76) Inventors: Thinh T. Nguyen, Onex (CH); Vittorio De Nora, Veyras (CH)

Correspondence Address: Jayadeep R Deshmukh, 458 Cherry Hill RD, Princeton, NJ, 08540, US

(21) Appl. No.: 10/585,531

(22) PCT Filed: Jan. 7, 2005
(86) PCT No.: PCT/IB05/00299

§ 371 Date: Jul. 10, 2006

(30) Foreign Application Priority Data
Jan. 9, 2004 (IB) 2004/000207

(51) Int. Cl. C25B 15/00; C04B 35/58; C04B 35/26; C04B 35/56; B32B 18/00; C25B 9/00; C04B 35/64; C25C 1/00

(52) U.S. Cl. 205/350; 501/96.3; 501/126; 501/127; 501/96.1; 428/457; 204/233; 264/681

(57) ABSTRACT

A ceramic material (20, 20A, 20B, 20C, 20C′, 20D, 20E, 20E₁, 20E₂, 20E₃, 20E₄, 20F) comprises a structural mass made of at least one refractory compound selected from refractory borides, aluminides and oxycompounds, and combinations thereof. This structural mass has an open microporosity that is impregnated with colloidal and/or polymeric particles of iron oxide and/or a precursor of iron oxide. These particles promote wetting of the structural mass by molten aluminum and/or form upon heat treatment a sintered barrier against oxygen diffusion through the structural mass. The ceramic material can be used on cathodes (15), carbon or metal-based anodes (5,5,′), sidewalls (16) and other parts (26) of aluminum electrowinning cells, on electrodes (15A) of arc furnaces, and on stirrers (10) or vessels (45) of aluminum purification apparatus.

### FIELD OF THE INVENTION

The invention relates to a ceramic material, in particular a material which is aluminum-wettable and/or resistant against oxygen diffusion. The ceramic material is suitable for use in metallurgical environments.

### BACKGROUND OF THE INVENTION

A number of activities, such as the production, purification and recycling of metals, in particular aluminum and steel, are usually carried out at high temperature in very aggressive environments such as molten metal, molten electrolyte and/or corrosive gas. Therefore, the materials used for the manufacture of components exposed to such environments must be thermally and chemically stable.

Graphite and other carbonaceous materials are commonly used for components, especially conductive components. Unfortunately, carbon components do not resist oxidation and/or corrosion and must be periodically replaced.

Several proposals have been made to reduce wear of carbon components in such technologies to achieve a higher operation efficiency, reduce pollution and the costs of operation.

In the field of steel recycling using arc electrode furnaces, it has been sought to reduce oxidation wear of inactive lateral faces of carbon arc electrodes, which is caused by exposure to oxygen at the high operating temperature. For instance, in U.S. Pat. No. 5,882,374 (Hendrix) it has been proposed to coat the inactive lateral face of the arc electrode with silica material to avoid consumption of the lateral face.

For the purification of molten metals, in particular molten aluminum, by the injection of a flux removing impurities towards the surface of the molten metal, it has been proposed to coat carbon components which are exposed to the molten metal with a coating of refractory material as disclosed in WO00/63630 (assigned to Moltech Invent S.A.).

In aluminum production, some components are exposed to molten fluoride-containing electrolyte, molten aluminum and/or anodically produced oxygen. In conventional Hall-Héroult cells these components are still made of consumable carbonaceous materials.

It has long been recognised that it would be desirable to make (or coat or cover) the cathode of an aluminum electrowinning cell with a refractory boride such as titanium diboride that would render the cathode surface wettable by molten aluminum which in turn would lead to a series of advantages.

For example, U.S. Pat. Nos. 5,310,476, 5,364,513, 5,651,874 and 6,436,250 (all assigned to Moltech Invent S.A.) disclose applying a protective coating of a refractory material such as titanium diboride to a carbon component of an aluminum electrowinning cell, by applying thereto a slurry of particulate refractory material and/or precursors thereof in a colloid in several layers with drying between each layer. WO01/42168, WO01/42531 and WO02/096831 (all assigned to Moltech Invent S.A.) disclose the use of a layer made of particulate oxide of Mn, Fe, Co, Ni, Cu, Zn, Mo or La (−325 mesh) mixed with refractory material and/or on a layer of refractory material. The use of these oxides promotes the wetting of the refractory material by molten aluminum. These patents also disclose the use of such materials for use in an oxidising and/or corrosive environment.

In the field of anodes for the electrowinning of aluminum, it has been proposed to substitute carbon anodes with metallic anodes. Such anodes are for example disclosed in U.S. Pat. Nos. 6,248,227, 6436,274, 6,521,115 and 6,562,224, and in WO00/40783, WO01/42534, WO01/42536, WO02/083991, WO03/014420 and WO03/078695 (all assigned to Moltech Invent S.A.). These anodes have an iron-containing metallic body which is covered with an integral iron oxide layer that is active for the oxidation of oxygen. During use, oxygen diffuses through the iron oxide layer to slowly oxidise the anode body and maintain the iron oxide layer by formation of iron oxide at the layer/body interface.

It has been proposed to protect metallic anode substrates against oxidation, especially against anodically evolved oxygen, by using between the substrate and an electrochemically active outer anode layer an intermediate layer of oxides of chromium, platinum-zirconium, niobium, nickel or nickel-aluminum, or carbides as disclosed in U.S. Pat. Nos. 4,956,068, 4,960,494, 5,069,771 (all Nguyen/Lazouni/Doan) and U.S. Pat. No. 6,077,415, and in WO00/06800, WO02/070786 and WO02/083990 (all assigned to Moltech Invent S.A.).

These materials have not as yet found wide commercial acceptance and there is a need to provide a ceramic material with improved properties for use in an oxidising and/or corrosive environment, in particular an environment at elevated temperature such as an aluminum or a steel production or purification environment.

### SUMMARY OF THE INVENTION

An object of the invention is to provide a refractory material which can be used to make or protect components for use at elevated temperature in oxidising and/or corrosive metallurgical environments, in particular in the production, purification or recycling of metals.

A particular object of the invention is to provide a refractory material which forms a barrier against oxygen diffusion and/or which is wettable by molten aluminum.

Another object of the invention is to provide an apparatus for the production, purification or recycling of aluminum or steel, having such components and a method to operate such apparatus.

Therefore, the invention relates to a ceramic material that comprises a structural mass made of at least one refractory compound selected from refractory borides, aluminides and oxycompounds, and combinations thereof. This structural mass has an open microporosity that is impregnated with colloidal and/or polymeric particles of iron oxide and/or a precursor of iron oxide. In particular, these particles promote wetting of the structural mass by molten aluminum and/or when subjected to heat treatment they can form a sintered barrier against oxygen diffusion through the structural mass.

In other words, the iron oxide in the ceramic material of the present invention is firmly anchored in the structural mass by impregnation of the colloidal and/or polymeric (usually inorganic) particles. The impregnated particles are less likely to be washed away during use than if they were applied in the form of an outer layer of a particulate that cannot, due to its size (−325 mesh), noticeably infiltrate a microporous structure, as disclosed in the abovementioned references WO01/42168, WO01/42531 and WO02/096831. Moreover, the impregnated particles are not part of the structural mass of the refractory material. Thus, when the material is used in a high temperature environment, possible reaction of the particles with the environment, in particular aluminum, does not alter/weaken the structural mass unlike the materials disclosed in these references.

When the colloidal and/or polymeric iron particles are sintered in the micropores of the structural mass, they form a compact sintered agglomerate in the mircopores that inhibits oxygen from diffusing therethrough. This sintered iron oxide is much denser than the iron oxide that is formed by surface oxidation of an iron-containing alloy and that does not prevent oxygen diffusion, as disclosed in the abovementioned U.S. Pat. Nos. 6,248,227, 6436,274, 6,521,115 and 6,562,224 and in WO00/40783, WO01/42534, WO01/42536, WO02/083991, WO03/014420 and WO03/078695 also mentioned above. Moreover, iron oxides are electrically more conductive compared to the usual candidates used to inhibit oxygen diffusion into electrodes, in particular chromium oxide, as disclosed in the abovementioned U.S. Pat. Nos. 4,956,068, 4,960,494, 5,069,771 and 6,077,415, and in WO00/06800, WO02/070786 and WO02/083990. It follows that the ceramic material of the present invention is useful for the production of any conductive article used in an aggressive environment, in particular at elevated temperature, such as electrodes.

The structural mass can comprise a refractory oxide made of oxynitrides, oxycarbides, oxyfluorides or metal oxides, or a mixture thereof.

Usually, the refractory compound comprises one or more borides, aluminides and oxycompounds of at least one metal selected from titanium, niobium, tantalum and molybdenum. For example the structural mass comprises titanium diboride and/or titanium oxide.

The colloidal and/or polymeric particles can be made of at least one of FeO(OH)₂, FeO, Fe₂O₃ and Fe₃O₄ and precursors thereof, all in colloidal and/or polymeric form. For instance, the particles comprise single oxides of iron, such as stoichiometric and/or non-stoichiometric ferrous oxide and hematite, which can react with the structural mass to increase the anchorage in the micropores. For example, when the mircoporous structural mass comprises titanium oxide, the ferrous oxide and/or hematite can react therewith to form a multiple boding oxide of titanium and iron.

Moreover, to promote the formation of magnetite from the colloidal and/or polymeric particles during heat treatment, the ceramic material of the invention can comprise a catalyst, in particular a copper compound such as copper oxide. The catalyst can be present in the microporous structural mass. Alternatively, the particles can be impregnated into the micropores in the presence of the catalyst. For example, the colloidal and/or polymeric particles are impregnated from a slurry containing the copper oxides and/or other catalyst(s).

Usually, the ceramic material of the invention is a coating on a substrate or a self-sustaining body.

The colloidal and/or polymeric particles may be sintered in the open microporosity of the structural mass. The sintering is not necessary, in particular when the ceramic material of the invention is wetted by molten aluminum before or during use.

The exposure of the colloidal and/or polymeric particles to molten aluminum leads to a reaction between the particles' iron oxide and the molten aluminum. This reaction produces a mixture of aluminum oxide, aluminum and iron which covers the ceramic material and which is anchored in the structural mass' microporosity. For This reaction to occur it is not necessary that the colloidal and/or polymeric particles be sintered. Wettability by molten aluminum is improved by the presence of this mixture of aluminum oxide, aluminum and iron. Furthermore, a film of aluminum at the surface of the ceramic material shields and protects the ceramic material from aggressive environments, in particular oxygen.

If the ceramic material is not intended to be wetted by molten aluminum but is nevertheless used in an aggressive environment, the colloidal and/or polymeric particles are preferably sintered so as to form a substantially impervious barrier in the mircoporosity of the structural mass against various aggressive environments. Typically, the ceramic material should not be wetted by a protective layer of molten aluminum if the material's intended use requires a high electrical conductivity of the material in an oxidising environment. Indeed, when aluminum is exposed to oxygen, it forms a highly resistive aluminum oxide film which should be avoided if the ceramic material is used to pass an electric current.

The invention also relates to a component which during use is exposed to an oxidising atmosphere. This component has a substrate that is protected from oxidation by a ceramic barrier layer made of a microporous material impregnated with colloidal and/or polymeric particles as disclosed above, the colloidal and/or polymeric particles being usually sintered.

For instance, when the component is an anode for the electrowinning of aluminum, the ceramic layer is covered with a protective layer that inhibits dissolution of the ceramic layer. The protective layer can comprises at least one of: iron oxides, such hematite and/or nickel ferrite; and cerium oxycompounds, in particular cerium oxyfluoride. Suitable materials for such a protective layer are for example disclosed in U.S. Pat. Nos. 6,103,090, 6,361,681, 6,365,018, 6,379,526, 6,413,406, 6,425,992, and in WO2004/018731, WO2004/025751 and WO2004/044268 (all assigned to Moltech Invent S.A.). The materials disclosed in the abovementioned U.S. Pat. Nos. 6,248,227, 6436,274, 6,521,115 and 6,562,224, and in WO00/40783, WO01/42534, WO01/42536, WO02/083991, WO03/014420 and WO03/078695 also mentioned above are also contemplated for making the protective layer. Alternatively, the protective layer can contain at least one of copper, nickel, silver, copper oxide and nickel oxide, and may be covered with an electrochemically active surface layer, for example a cerium oxyfluoride layer as disclosed in the abovementioned U.S. Pat. Nos. 4,956,068, 4,960,494, 5,069,771 and 6,077,415, and in WO00/06800, WO02/070786 and WO02/083990 also mentioned above.

The substrate of the component can be metal-based. In particular the metal-based substrate contains at least one metal selected from chromium, cobalt, hafnium, iron, molybdenum, nickel, niobium, platinum, silicon, tantalum, titanium, tungsten, vanadium, yttrium and zirconium. The substrate can contain an iron alloy of nickel and/or cobalt, for instance an iron alloy as disclosed in the abovementioned references.

The invention further relates to a component which before use or during use is exposed to molten aluminum. Such component has an aluminum-wettable surface formed by the sintered or non-sintered ceramic material described above.

The component can be made of this ceramic material or can comprise a layer of this ceramic material on a substrate, in particular a carbon substrate.

For example, the component is one of: a cathode, a cell bottom or a sidewall of an aluminum electrowinning cell; a holder for arc electrodes or an arc electrode, in particular a consumable carbon arc electrode with its inactive surface protected by a layer of the inventive ceramic material; or a component of an apparatus for treating molten aluminum, in particular a stirrer for stirring molten aluminum, a pipe for supplying a treating agent to molten aluminum, or a vessel for containing molten aluminum.

Another aspect of the invention relates to a cell for the electrowinning of aluminum from alumina dissolved in a molten electrolyte. This cell comprises at least one anode as disclosed above. This anode has a substrate that is covered with a ceramic barrier layer and a protective layer. Optionally, the cell further comprises a cathode and/or a sidewall that contain the ceramic material of the invention as described above.

A further aspect of the invention relates to a method of electrowinning aluminum in such a cell. This method comprises passing an electrolysis current from the cathode to the anode through the molten electrolyte to electrolyse the dissolved alumina whereby aluminum is produced on the cathode and oxygen is evolved on the anode, the ceramic barrier layer inhibiting oxidation of the substrate by the evolved oxygen.

Yet another aspect of the invention relates to a cell for the electrowinning of aluminum from alumina dissolved in a molten electrolyte. This cell comprises at least one cathode as disclosed above. The cathode has an aluminum-wettable surface. Optionally, the cell has an anode and/or a sidewall that comprise(s) the ceramic material of the invention as mentioned above.

Yet a further aspect of the invention relates to a method of electrowinning aluminum in such a cell. This method comprises passing an electrolysis current from the cathode to the anode through the molten electrolyte to electrolyse the dissolved alumina whereby aluminum is produced on the cathode and gas is evolved on the anode, the aluminum-wettable surface being wetted by aluminum.

The invention also relates to: an arc furnace comprising at least one component containing the inventive ceramic material; as well as a method of operating this arc furnace. When the component is a carbonaceous arc electrode, the ceramic material of the invention should be present on its inactive surfaces, as discussed below.

The invention further relates to an apparatus for treating molten aluminum comprising at least one component containing the inventive ceramic material, the component being a stirrer, a pipe or a vessel.

Another aspect of the invention relates to a method of operating such an apparatus. This method comprises when the device is a stirrer, a pipe or a vessel, respectively: stirring molten aluminum with said component; supplying a treating agent to molten aluminum through said component; or confining molten aluminum in said component.

An even further aspect of the invention concerns a method of producing a ceramic material. This method comprises the steps of: providing a structural mass that has an open microporosity and that is made of a refractory compound selected from borides, aluminides and oxycompounds, and combinations thereof; and impregnating the open microporosity with colloidal and/or polymeric particles of iron oxide and/or a heat-convertible precursor thereof.

These colloidal and/or polymeric particles can be sintered in the open microporosity of the structural mass by a heat treatment.

Usually, the structural mass is formed by sintering a ceramic particulate, typically a particulate having a particle size below 100 micron, in particular having an average particle size in the range of 1 to 60 micron, for example 10 to 50 micron.

The ceramic particulate can be suspended in a slurry which is dried before sintering. The slurry may contain a colloid and/or a polymer. Typically the slurry comprises: colloidal particles selected from lithia, beryllium oxide, magnesia, alumina, silica, titania, vanadium oxide, chromium oxide, manganese oxide, iron oxide, gallium oxide, yttria, zirconia, niobium oxide, molybdenum oxide, ruthenia, indium oxide, tin oxide, tantalum oxide, tungsten oxide, thallium oxide, ceria, hafnia and thoria, and precursors thereof, all in the form of colloids; and/or polymeric particles selected from lithia, beryllium oxide, alumina, silica, titania, chromium oxide, iron oxide, nickel oxide, gallium oxide, zirconia, niobium oxide, ruthenia, indium oxide, tin oxide, hafnia, tantalum oxide, ceria and thoria, and precursors thereof, all in the form of polymers. The slurry may contain at least one organic compound selected from ethylene glycol, hexanol, polyvinyl alcohol, polyvinyl acetate, polyacrylic acid, hydroxy propyl methyl cellulose and ammonium polymethacrylate and mixtures thereof.

Examples of structural masses formed by drying and sintering a slurry are given in the abovementioned U.S. Pat. Nos. 5,310,476, 5,364,513, 5,651,874 and 6,436,250, and in WO01/42168, WO01/42531 and WO02/096831 also mentioned above. Alternatively, the structural mass can be formed by powder pressing and sintering or plasma spraying or other known techniques.

The colloidal and/or polymeric particles of iron oxide and/or their precursor(s) can be impregnated into the dry green structural mass, i.e. before sintering the particulate of the mass, or they can be impregnated after sintering the structural mass.

Generally, the invention concerns a ceramic material that comprises a structural mass made of a refractory compound selected from borides, aluminides. and oxycompounds, and combinations thereof. This structural mass has an open microporosity that is impregnated with colloidal and/or polymeric particles of iron oxide and/or a precursor of iron oxide. This ceramic material can have any of the characteristics mentioned above.

In particular, the colloidal and/or polymeric particles may or may not be sintered in the open microporosity and constitute an agent to promote wetting of the structural mass by molten aluminum. Furthermore, the colloidal and/or polymeric particles can form a sintered barrier against oxygen diffusion through the structural mass.

### BRIEF DESCRIPTION OF THE DRAWINGS

Embodiments of the invention will now be described by way of example with reference to the accompanying schematic drawings, wherein:

FIG. 1 shows a schematic cross-sectional view of an aluminum production cell with carbonaceous drained cathodes, anodes and sidewalls, all having a layer made of the ceramic material of the invention;

FIG. 2 is a cross-sectional view through a metal-based aluminum production anode having an oxygen barrier layer made of the ceramic material of the invention;

FIG. 3 schematically shows an arc electrode furnace coated with layers of the inventive ceramic material;

FIG. 4 shows an apparatus for the purification of a molten metal having a carbonaceous stirrer protected with a layer of the inventive ceramic material;

FIG. 4a is an enlarged schematic sectional view of part of the stirrer shown in FIG. 4; and

FIG. 5 schematically shows a variation of the stirrer shown in FIG. 4.

### DETAILED DESCRIPTION

### Aluminum Electrowinning Cell:

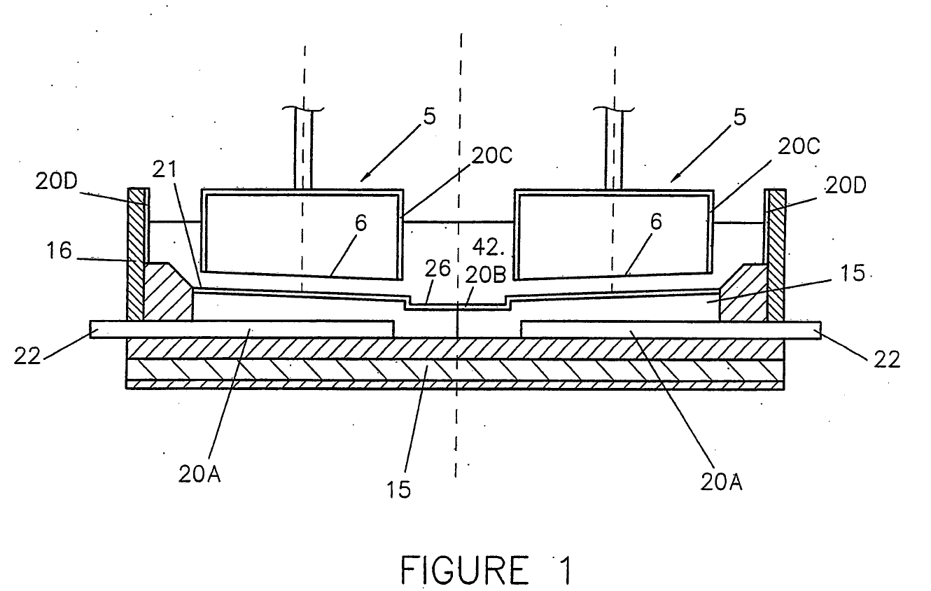

FIG. 1 shows an aluminum electrowinning cell comprising a series of carbonaceous anode blocks 5 having operative surfaces 6 suspended over drained sloping flattened generally V-shaped cathode surface 21 in a fluoride-containing molten electrolyte 42 containing dissolved alumina.

The drained cathode surface 21 is formed by the surface of a layer 20A of the aluminum-wetted inventive ceramic material that is applied to the upper surfaces of a series of juxtaposed carbon cathode blocks 15 extending in pairs arranged end-to-end across the cell. Layer 20A contains a sintered particulate of TiB₂ having micropores impregnated with colloidal and/or polymeric iron oxide particles. After exposure of layer 20A to molten aluminum, the layer's iron oxide particles react in the pores with molten aluminum to form a mixture of aluminum oxide, aluminum and iron metal which enhances the aluminum-wettability of layer 20A.

The cathode blocks 15 comprise, embedded in recesses located in their bottom surfaces, current supply bars 22 of steel or other conductive material for connection to an external electric current supply.

The drained cathode surface 21 is divided by a central aluminum collection groove 26 located in or between pairs of cathode blocks 15 arranged end-to-end across the cell. The aluminum collection groove 26 is situated at the bottom of the drained cathode surface 21 and is arranged to collect the product aluminum draining from the cathode surface 21. The aluminum collection groove 26 is coated with an aluminum-wetted layer 20B of the inventive ceramic material.

The carbon anode blocks 5 too are coated with a layer 20C of the inventive ceramic material on their inactive surfaces. Layer 20C is made of a sintered particulate of titanium oxide infiltrated with sintered colloidal and/or polymeric iron oxide particles. Alternatively, layer 20C is made of the inventive ceramic material that is wetted by molten aluminum, i.e. before use of the anode block 5 the inventive ceramic material is exposed to molten aluminum which reacts with the iron oxide in the micropores of the ceramic material and infiltrates the surface of the ceramic material, the molten aluminum at the surface of layer 20C forming a barrier to oxygen diffusion.

Layer 20C inhibits oxidation of the anode's shoulders and side faces during use. Anode blocks 5 remain uncoated on the operative anode surfaces 6 which are immersed as such in the molten electrolyte 42 and which are consumed during use.

The cell comprises carbonaceous sidewalls 16 exposed to molten electrolyte 42 and to the environment above the molten electrolyte, but protected against the molten electrolyte 42 and the environment above the molten electrolyte with a layer 20D of the inventive ceramic material that is wetted with molten aluminum before use.

In operation of the cell illustrated in FIG. 1, alumina dissolved in the molten electrolyte 42 at a temperature of 750° to 960° C. is electrolysed between the anodes 5 and the cathode blocks 15 to produce gas on the operative anodes surfaces 6 and molten aluminum on the aluminum-wetted drained cathode layer 20A.

The cathodically-produced molten aluminum flows down the inclined drained cathode surface 21 into the aluminum collection grooves 26 onto the aluminum-wetted layer 20B from where it flows into an aluminum collection reservoir for subsequent tapping.

FIG. 1 shows a specific aluminum electrowinning cell by way of example. It is evident that many alternatives, modifications, and variations will be apparent to those skilled in the art. For instance, the cell may have one or more aluminum collection reservoirs across the cell, each intersecting the aluminum collection groove to divide the drained cathode surface into four quadrants as described in WO00/63463 (all assigned to Moltech Invent S.A.).

The cell bottom may have a horizontal aluminum-wettable cathode surface which is in a drained configuration or which is covered with a shallow or deep pool of aluminum, for example as disclosed in U.S. Pat. Nos. 5,683,559, 5,888,360, 6,093,304 (all assigned to Moltech Invent S.A.) and in the abovementioned U.S. Pat. No. 5,651,874.

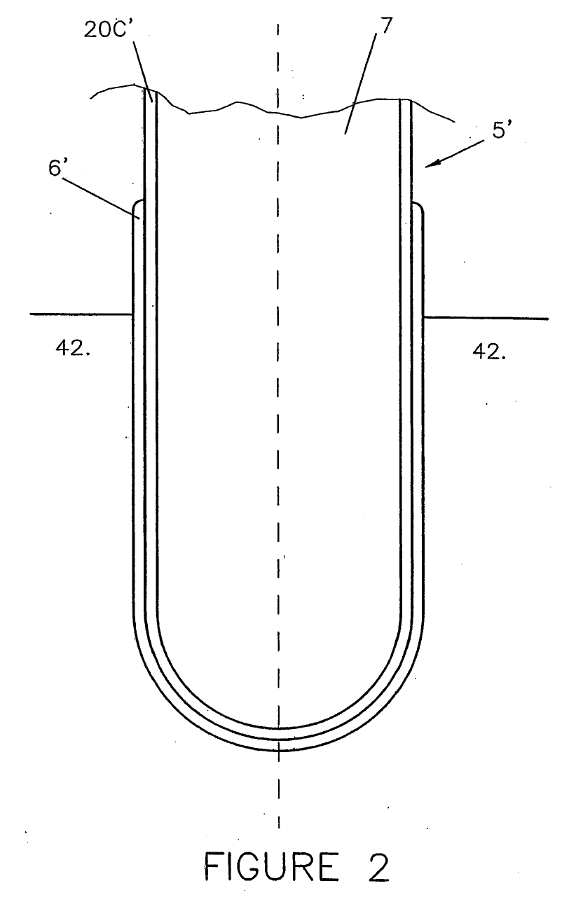

FIG. 2 shows a metal-based anode 5′ according to the invention which is immersed in an electrolyte 42. The anode 5′ has a metallic substrate 7, for example made of nickel or a nickel alloy, covered with an oxygen barrier layer 20C′ made of the ceramic material of the invention that comprises a microporous structural mass impregnated with sintered colloidal and/or polymeric iron oxide particles, the sintered iron oxide forming an agglomerate in the structural mass' micrpores that inhibits diffusion of oxygen through the structural mass.

On the oxygen barrier layer 20C′ there is a layer 6′ which is electrochemically active for the oxidation of oxygen and which protects the oxygen barrier layer 20C′ against electrolyte 42. The electrochemically active layer 6′ can be made of iron oxides, as disclosed in the abovementioned U.S. Pat. Nos. 6,103,090, 6,361,681, 6,365,018, 6,379,526, 6,413,406, 6,425,992, and in WO2004/018731, WO2004/024994 and WO2004/044268 also mentioned above.

Active layer 6′ covers anode 5′ and the oxygen barrier layer 20C′ where exposed to the electrolyte 42 and prevents dissolution of the barrier into molten electrolyte. However, active layer 6′ may extend far above the surface of the electrolyte 5, up to the connection with a positive current bus bar.

The anode shown in FIG. 2 is in the shape of a vertical rod with a hemispherical bottom. Alternatively, the anodes may have an electrochemically active structure of grid-like design to permit electrolyte circulation, as for example disclosed in WO00/40781, WO00/40782, WO03/006716 and WO03/023092 (all assigned to Moltech Invent S.A.), or another design.

As mentioned above, the anodes may be coated with a protective layer of one or more cerium compounds, in particular cerium oxyfluoride. The protective layers can be maintained by maintaining an amount of cerium species in the electrolyte.

### Arc Furnace:

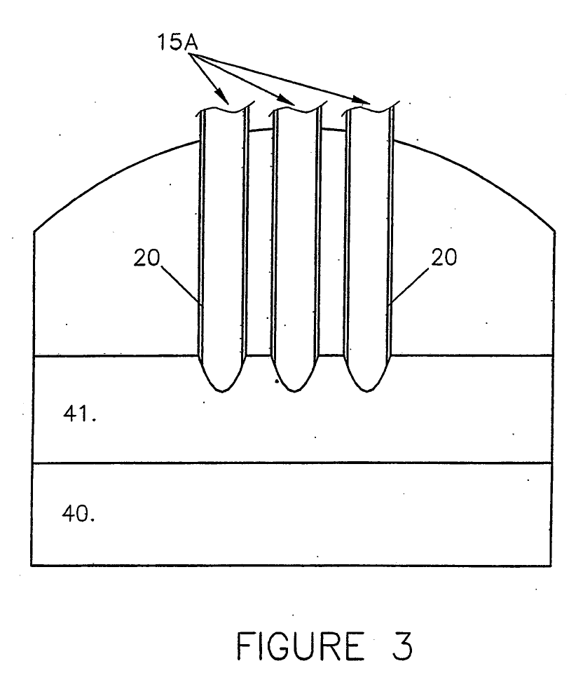

The arc furnace shown in FIG. 3 comprises three consumable electrodes 15A arranged in a triangular relationship. For clarity, the distance between the electrodes 15A as shown in FIG. 3 has been proportionally increased with respect to the furnace. Typically, the electrodes 15A have a diameter between 200 and 500 mm and can be spaced by a distance corresponding to about their diameter.

The electrodes 15A are connected to an electrical power supply (not shown) and suspended from an electrode positioning system above the cell which is arranged to adjust their height.

The consumable electrodes 15A are made of a carbon substrate laterally coated with a layer 20 of the inventive ceramic material impregnated with sintered colloidal and/or polymeric particles made of iron oxide protecting the carbon substrate from oxidising gas. Alternatively, layer 20 is made of the inventive ceramic material that is wetted before use by molten aluminum, the molten aluminum at the surface of layer 20C forming a barrier to oxygen diffusion as mentioned above.

The bottom of electrodes 15A which is consumed during operation and constitutes the electrodes' operative surface is uncoated. The protective layer 20 protects only the electrodes' lateral faces against premature oxidation.

The electrodes 15A dip in an iron source 41, usually containing iron oxide or oxidised iron, such as scrap iron, scrap steel and pig iron. Preferably, the iron source 41 further comprises reductants selected from gaseous hydrogen, gaseous carbon monoxide or solid carbon bearing reductants. The reductants may also comprise non-iron minerals known as gangue which include silica, alumina, magnesia and lime.

The iron source 41 floats on a pool of liquid iron or steel 40 resulting from the recycling of the iron source 41.

During use, a three phase AC current is passed through electrodes 15A, which directly reduces iron from the iron source 41. The reduced iron is then collected in the iron or steel pool 40. The gangue contained in the reduced iron is separated from the iron by melting and flotation forming a slag (not shown) which is removed, for example through one or more apertures (not shown) located on sidewalls of the arc furnace at the level of the slag.

The pool of iron or steel 40 is periodically or continuously tapped for instance through an aperture (not shown) located in the bottom of the arc furnace.

### Molten Metal Purification Apparatus:

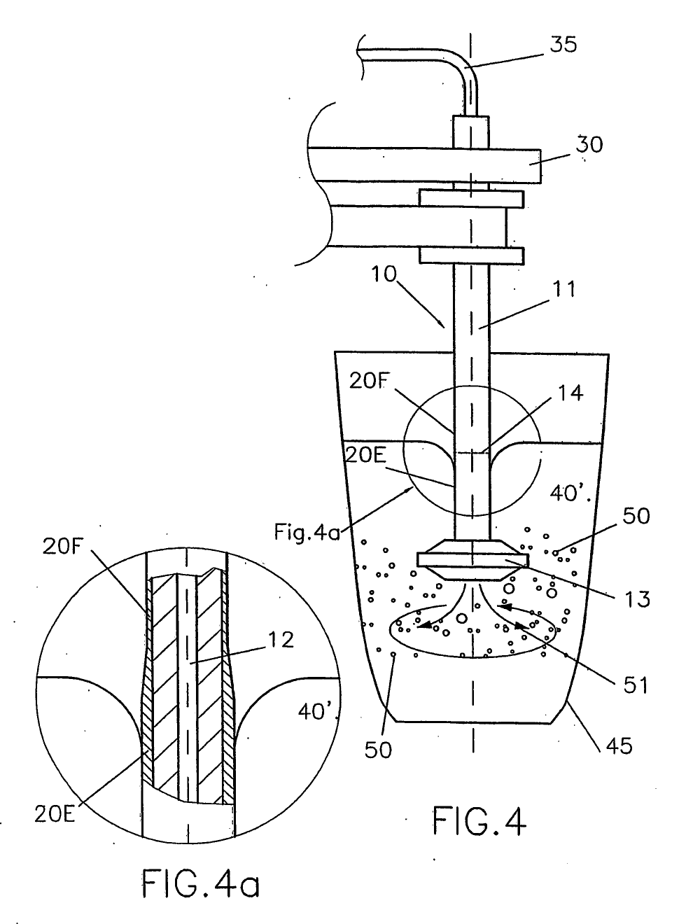

The molten metal purification apparatus partly shown in FIG. 4 comprises a vessel 45 containing molten metal 40′, such as molten aluminum, to be purified. A rotatable stirrer 10 made of carbon-based material, such as graphite, is partly immersed in the molten metal 40′ and is arranged to rotate therein.

The stirrer 10 comprises a shaft 11 whose upper part is engaged with a rotary drive and support structure 30 which holds and rotates the stirrer 10. The lower part of shaft 11 is carbon-based and dips in the molten metal 40′ contained in vessel 45. At the lower end of the shaft 11 is a rotor 13 provided with flanges or other protuberances for stirring the molten metal 40′.

Inside shaft 11, along its length, is an axial duct 12, as shown in FIG. 4a, which is connected at the stirrer's upper end through a flexible tube 35 to a gas supply (not shown), for instance a gas reservoir provided with a gas gate leading to the flexible tube 35.

The axial duct 12 is arranged to supply a fluid to the rotor 13. The rotor 13 comprises a plurality of apertures connected to the internal duct 12 for injecting the gas into the molten metal 40′, as shown by arrows 51.

The lower part of the shaft 11, i.e. the immersed part and the interface region at or about the meltline 14 of the shaft, as well as the rotor 13 are coated according to the invention with a layer 20E of the inventive ceramic material that is wetted by aluminum. Layer 20E improves the resistance to erosion, oxidation and/or corrosion of the stirrer during operation.

As shown in FIG. 4, the upper part of shaft 11 is also protected against oxidation and/or corrosion by a layer 20F of the inventive ceramic material. The upper part of the carbon-based shaft 11 is coated with a thin layer of refractory material 20F providing protection against oxidation and corrosion, whereas the layer 20E protecting the immersed part of the shaft 11 and the rotor 13 is a thicker layer of refractory material providing protection against erosion, oxidation and corrosion.

Likewise, surfaces of the vessel 45 which come into contact with the molten metal may be protected with an layer of the ceramic material according to the invention.

During operation of the apparatus shown in FIG. 4, a reactive or non-reactive fluid, in particular a gas 50 alone or a flux, such as a halide, nitrogen and/or argon, is injected into the molten metal 40′ contained in the vessel 45 through the flexible tube 35 and stirrer 10 which dips in the molten metal 40′.

The stirrer 10 is rotated at a speed of about 100 to 500 RPM so that the injected gas 50 is dispersed throughout the molten metal in finely divided gas bubbles. The dispersed gas bubbles 50, with or without reaction, remove impurities present in the molten metal 40′ towards its surface, from where the impurities may be separated thus purifying the molten metal.

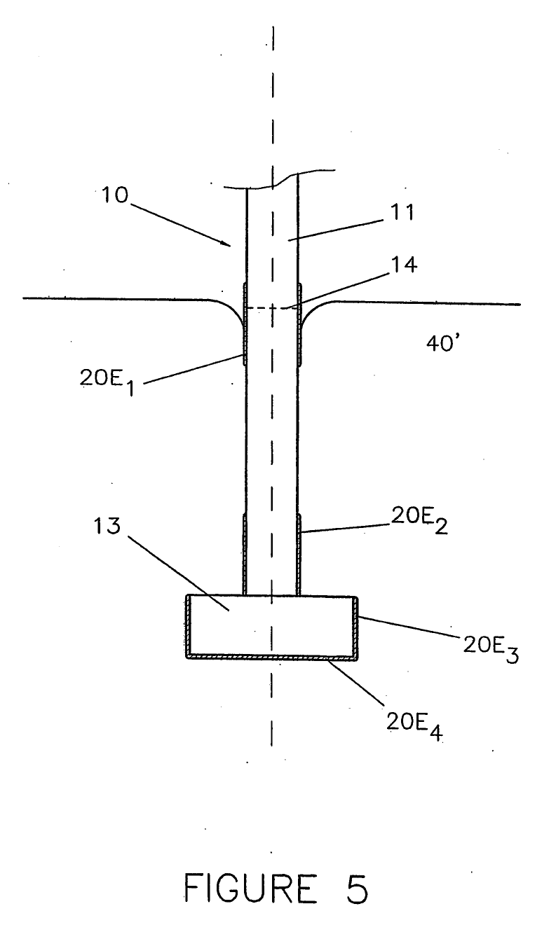

The stirrer 10 schematically shown in FIG. 5 dips in a molten metal bath 40′ and comprises a shaft 11 and a rotor 13. The stirrer 10 may be of any type, for example similar to the stirrer shown in FIG. 4 or of conventional design as known from the prior art. The rotor 13 of stirrer 10 may be a high-shear rotor or a pump action rotor.

In FIG. 5, instead of coating the entire shaft 11 and rotor 13, parts of the stirrer 10 liable to erosion are selectively coated with a layer of the ceramic material according to the invention.

The interface portion at and about the meltline 14 of the carbon-based lower part of the shaft 11 is coated with a refractory interface layer 20E₁ consisting of the aluminum-wetted inventive ceramic material, for instance over a length of up to half that of the shaft 11. Excellent results have been obtained with a layer over a third of shaft 11. However, the length of layer 20E₁ could be a quarter of the length of shaft 11 or even less, depending on the design of stirrer 10 and the operating conditions.

In addition to the interface portion of such stirrers, other areas may be liable to erode, again depending on the design and operating conditions of the stirrers. The schematically shown stirrer 10 in FIG. 5 illustrates further coated surfaces which are particularly exposed to erosion. The lower end of the shaft 11 adjacent to the rotor 13 is protected with a layer 20E₂ of the inventive ceramic material. The lateral surface of rotor 13 is protected with a layer 20E₃ and the bottom surface of the rotor 13 is coated with a layer 20E₄, both consisting of the inventive ceramic material.

For each specific stirrer design, the layer or different protective layers on different parts of the stirrer, such as layers 20E₁, 20E₂, 20E₃ and 20E₄ shown in FIG. 5, may be adapted as a function of the expected lifetime of the stirrer. For optimal use, the amount and location of such layers can be so balanced that they each have approximately the same lifetime.

In an alternative embodiment (not shown), the layer on such stirrers may be continuous as illustrated in FIG. 4 but with a graded thickness or composition so as to adapt the resistance against erosion to the intensity of wear of each part of the stirrer, thereby combining the advantages of the different layers shown in FIG. 5.

Various modifications can be made to the apparatus shown in FIGS. 4, 4a and 5. For instance, the shaft shown in FIG. 4 may be modified so as to consist of an assembly whose non-immersed part is made of a material other than carbon-based, such as a metal and/or a ceramic, which is resistant to oxidation and corrosion and which, therefore, does not need any protective layer, whereas the immersed part of the shaft is made of carbon-based material protected with a protective layer of the inventive ceramic material. Such a composite shaft would preferably be designed to permit disassembly of the immersed and non-immersed parts so the immersed part can be replaced when worn.

Likewise, a carbon-based non-immersed part of the shaft may be protected from oxidation and corrosion with a layer and/or impregnation of a phosphate of aluminum, in particular applied in the form of a compound selected from monoaluminum phosphate, aluminum phosphate, aluminum polyphosphate, aluminum metaphosphate, and mixtures thereof as disclosed in U.S. Pat. No. 5,534,119 (assigned to Moltech Invent S.A.). It is also possible to protect the non-immersed part of the shaft with a layer and/or impregnation of a boron compound, such as a compound selected from boron oxide, boric acid and tetraboric acid as disclosed in U.S. Pat. Nos. 5,486,278 and 6,228,424 (all assigned to Moltech Invent S.A.).

In a modification, the protective layer of the invention may simply be applied to any part of the stirrer in contact with the molten metal, to be protected against erosion, oxidation and/or corrosion during operation.

Layers 20, 20A, 20B, 20C, 20C′, 20D, 20E, 20E₁, 20E₂, 20E₃, 20E₄, 20F can be bonded to the underlying carbon through a thin intermediate bonding layer applied from a slurry containing refractory particles and a carbon compound having a hydrophilic substituent which bonds the hydrophilic refractory particles to the hydrophobic carbon, as for instance disclosed in the abovementioned WO02/096831.

The invention will be further described in the following examples.

### COMPARATIVE EXAMPLE 1

An unprotected sample having a diameter of 20 mm and a length of 20 mm was made from a metal alloy that contained 57 wt % Ni, 10 wt % Cu and 32 wt % Fe, the balance being Mn, Si and Al. The sample was submitted to an oxidation treatment in air for 50 hours at 930° C.

After this oxidation treatment, the sample was examined in cross-section. An oxide scale had grown at the sample's surface over a thickness of 50 to 70 micron.

The oxidation had also penetrated into the sample's metal alloy over a depth of about 100 micron forming oxide inclusions having a diameter of the order of about 5 to 10 micron.

### EXAMPLE 1

A sample made of an alloy as in Comparative Example 1 was protected against oxidation with a ceramic material according to the invention.

An 85 micron-thick coating made of the ceramic material was formed by applying onto the sample several layers of a colloidal slurry containing: 56.5 wt % of particulate TiB₂ having a particle size that was smaller than 12 micron; 2.7 wt % of particulate TiO₂ having the same particle size; 16.4 wt % of Al₂O₃ colloid CONDEA® 10/2 Sol (a clear, opalescent liquid with a colloidal particle size of about 10 to 30 nanometer); and 24.4 wt % of Al₂O₃ colloid NYACOL® Al-20 (a milky liquid with a colloidal particle size of about 40 to 60 nanometer). The applied layers were dried and then impregnated with a colloid made of 50 wt % iron hydroxide colloid (“Transparent Red Dispersion” from JOHNSON MATHEY®) and 50 wt % of an aqueous solution containing 5 wt % PVA having a molecular weight (MW) of 47000 to 74000.

The coated alloy sample was heat treated at 930° C. for 50 hours in air as in Comparative Example 1. During the initial phase of the heat treatment, the ceramic material was sintered on the alloy sample to form a structural mass having an open microporosity and the impregnated colloidal iron hydroxide particles were turned into iron oxide particles and sintered in the microporosity of the structural mass to form a sintered barrier against oxygen diffusion through the structural mass to the alloy sample.

After this heat treatment, the sample was examined in cross-section. An oxide scale had grown at the sample's surface over a thickness of only about 10 micron instead of the 50 to 70 micron of Comparative Example 1. The oxidation had also penetrated into the sample's metal alloy over a depth of only about 20 micron forming oxide inclusions having a diameter of only about 4 micron instead of the 100 micron oxide penetration with inclusions of 5-10 micron observed in the sample of Comparative Example 1.

It followed that this coating of impregnated ceramic material decreased by 80 to 85% the oxidation of the sample.

### COMPARATIVE EXAMPLE 2

A graphite sample having a diameter of 80 mm and a height of 20 mm was covered with an openly microporous TiB₂-based coating applied from a colloidal slurry having the composition of the TiB₂-containing slurry of Example 1. Several layers of the slurry were applied onto the sample and dried so that the resulting coating had a thickness of about 1 mm. After 12 hours drying, the coated sample was heat treated at 650° C. for 4 hours in air without prior impregnation of the sample's coating with colloidal iron oxide particles.

After this heat treatment, the coated substrate was examined in cross-section. The sample's coating had turned light yellow due to the formation of titanium oxide by oxidation of the coating over a depth of about 100 micron below the coating's surface.

### EXAMPLE 2

A graphite sample covered with an openly microporous TiB₂-coating as in Comparative Example 2 had its coating (structural mass) impregnated after drying with a colloid made of 50 wt % iron hydroxide colloid (“Transparent Red Dispersion” from JOHNSON MATHEY®) and 50 wt % of an aqueous solution containing 5 wt % PVA having a molecular weight (MW) of 47000 to 74000, in accordance with the invention

After drying for 12 hours at room temperature, the coated graphite sample was heat treated like in Comparative Example 2.

After this heat treatment, the coated substrate was examined in cross-section. The sample's coating was black and had over a depth of about 10 micron below its surface a dense and continuous layer of mixed titanium-iron oxides that had been formed by sintering of the iron colloid (iron hydroxide) impregnation and the coating's structural mass. Underneath, the coating's TiB₂ had not been oxidised, demonstrating that the iron impregnation formed a barrier against oxygen diffusion through the structural mass.

### COMPARATIVE EXAMPLE 3

A coated graphite sample prepared and dried as in Comparative Example 2 was covered with two aluminum sheets having a thickness of 5 mm. The aluminum-covered coated sample was placed in a furnace and heated from room temperature to a temperature of 950° C. at a rate of 250° C./hour. The sample was maintained for 24 hours at 950° C. to aluminise the coating.

After aluminisation, the sample was allowed to cool down to room temperature and then examined in cross-section.

The coated sample was aluminised in the central part of the coating whereas the peripheral part of the coating had been heavily oxidised to form a non-wettable white-yellow titanium oxide layer.

### EXAMPLE 3

A coated graphite sample was prepared as in Comparative Example 3 except that the coating was impregnated according to the invention with an iron hydroxide based colloid as in Example 2 prior to covering with aluminum sheets. The sample was heat treated with the aluminum sheets for aluminisation like in Comparative Example 3.

After aluminisation, the sample was allowed to cool down to room temperature and then examined in cross-section.

As opposed to Comparative Example 3, the sample had its entire coating aluminised. During the heat treatment, the iron oxide impregnation initially acted as an oxygen barrier inhibiting formation of non-wettable white-yellow titanium oxide layer, and subsequently promoted aluminisation of the coating by reaction with molten aluminum to form a mixture of aluminum, iron and aluminum oxide.

### COMPARATIVE EXAMPLE 4

A comparative anode was prepared from an alloy as in Comparative Example 1 that was covered with an electrochemically active coating by dipping the alloy in a slurry of particulate nickel ferrite suspended in an iron hydroxide colloid followed by drying for 12 hours at 250° C. This dried nickel ferrite active coating had a thickness of 350 to 370 micron.

The anode was used to evolve oxygen in an aluminum electrowinning cell using a cryolite-based electrolyte at 925° C. An electrolysis current was passed through the anode at a current density of 0.8 A/cm² at its surface. After 200 hours electrolysis, the anode was removed from the cell and allowed to cool down to room temperature.

Examination of the anode showed that the alloy underneath the nickel ferrite coating had been oxidised over a thickness of 250 to 300 micron. This led to a volume increase underneath the coating which caused a light delamination of the coating and the formation in the coating of small cracks that had a depth of up to 300 micron and that were filled with cryolite-based electrolyte from the cell.

### EXAMPLE 4

An anode according to the invention was prepared as in Comparative Example 4 except that before coating the anode with the nickel ferrite active coating, a 90 micron thick oxygen barrier layer was formed on the anode's alloy.

The oxygen barrier layer was formed by applying onto the anode's alloy several layers of a colloidal slurry containing 28 wt % of particulate TiB₂ having a particle size that was smaller than 12 micron; 31.2 wt % of particulate TiO₂ having the same particle size; 16.4 wt % of Al₂O₃ colloid CONDEA® 10/2 Sol (a clear, opalescent liquid with a colloidal particle size of about 10 to 30 nanometer); and 24.4 wt % of Al₂O₃ colloid NYACOL® Al-20 (a milky liquid with a colloidal particle size of about 40 to 60 nanometer). The applied layers were dried and then impregnated with a colloid made of 50 wt % iron hydroxide colloid (“Transparent Red Dispersion” from JOHNSON MATHEY®) and 50 wt % of an aqueous solution containing 5 wt % PVA having a molecular weight (MW) of 47000 to 74000.

The impregnated layers of the oxygen barrier were allowed to dry for 12 hours at room temperature before application like in Comparative Example 4 of the active nickel ferrite coating onto the anode.

The anode was used to evolve oxygen in an aluminum electrowinning cell as in Comparative Example 4. After 200 hours, the anode was removed from the cell and allowed to cool down to room temperature.

Examination of the anode showed that the anode's alloy had been oxidised to form a very dense oxide layer of about 50 micron thick (instead of the 250 to 300 micron oxidation depth of the alloy of Comparative Example 4). This oxidation did not lead to an excessive volume increase underneath the nickel ferrite coating which thus did not delaminate or crack. However, the nickel ferrite coating had some open pores formed by dissolution that were filled with cryolite-based electrolyte from the cell.

This shows that the presence of the oxygen barrier layer made of the openly microporous structural mass impregnated with the colloidal particles of iron oxide precursor (iron hydroxide) according to the invention inhibited diffusion of oxygen to the anode's alloy and thus inhibited oxidation of the anode's alloy.

### EXAMPLE 5

In a variation, the protective effect of the ceramic material of Examples 1, 2, 3 and 4 can be improved by sintering the impregnated ceramic material of the invention in an inert atmosphere before exposure to an oxidising atmosphere. Moreover, the protective effect can be further improved by. pre-sintering the TiB₂-based structural mass before impregnation with the iron hydroxide colloid.

1. A ceramic material comprising a structural mass made of at least one refractory compound selected from refractory borides, aluminides and oxycompounds, and combinations thereof, said structural mass having an open microporosity that is impregnated with colloidal and/or polymeric particles of iron oxide and/or a precursor of iron oxide, said particles promoting wetting of the structural mass by molten aluminum and/or forming upon heat treatment a sintered barrier against oxygen diffusion through the structural mass.

2. The material of claim 1, wherein the structural mass comprises one or more oxycompounds selected from: refractory oxynitrides, oxycarbides, oxyfluorides and metal oxides.

3. The material of claim 1 or 2, wherein the refractory compound comprises one or more borides, aluminides and oxycompounds of at least one metal selected from titanium, niobium, tantalum and molybdenum.

4. The material of any preceding claim, wherein the colloidal and/or polymeric particles are made of at least one of FeO(OH)₂, FeO, Fe₂O₃ and Fe₃O₄ and precursors thereof, all in colloidal and/or polymeric form.

5. The material of any preceding claim, comprising a catalyst to promote the formation of magnetite from the colloidal and/or polymeric particles during heat treatment, in particular a catalyst made of a copper compound such as copper oxide.

6. The material of any preceding claim, wherein the colloidal and/or polymeric particles are sintered in the open microporosity of the structural mass.

7. The material of any preceding claim, which is a coating on a substrate.

8. The material of any one of claims 1 to 6, which is a self-sustaining body.

9. A component which during use is exposed to an oxidising atmosphere, said component having a substrate that is protected from oxidation by a ceramic barrier layer made of a material as defined in claim 7, in particular when depending on claim 6.

10. The component of claim 9, which is an anode for the electrowinning of aluminum, the ceramic layer being covered with a protective layer that inhibits dissolution of said ceramic layer.

11. The component of claim 10, wherein the protective layer comprises at least one of: iron oxides, such hematite and/or nickel ferrite; and cerium oxycompounds, in particular cerium oxyfluoride.

12. The component of claim 10, wherein the protective layer contains at least one of: copper; nickel; silver; copper oxide; and nickel oxide, the protective layer being covered with an electrochemically active surface layer.

13. The component of any one of claims 9 to 12, wherein the substrate is metal-based.

14. The component of claim 13, wherein the metal-based substrate contains at least one metal selected from chromium, cobalt, hafnium, iron, molybdenum, nickel, niobium, platinum, silicon, tantalum, titanium, tungsten, vanadium, yttrium and zirconium.

15. The component of claim 14, wherein the substrate contains an iron alloy of nickel and/or cobalt.

16. A component which before use or during use is exposed to molten aluminum, said component having an aluminum-wettable surface formed by the ceramic material of any one of claims 1 to 8.

17. The component of claim 16, which is made of said ceramic material or which comprises a layer of said ceramic material on a substrate, in particular a carbon substrate.

18. The component of claim 16 or 17, which is a cathode, a cell bottom or a sidewall of an aluminum electrowinning cell.

19. The component of claim 16 or 17, which is an arc electrode or a holder for an arc electrode.

20. The component of claim 16 or 17, which is a component of an apparatus for treating molten aluminum, in particular a stirrer for stirring molten aluminum, a pipe for supplying a treating agent to molten aluminum, or a vessel for containing molten aluminum.

21. A cell for the electrowinning of aluminum from alumina dissolved in a molten electrolyte, which cell comprises: a cathode; and at least one component as defined-in any one of claims 10 to 15 which is an anode and which has a substrate that is covered with said ceramic barrier layer and said protective layer.

22. The cell of claim 19, comprising a component as defined in claim 16 or 17 that forms said cathode or a sidewall.

23. A method of electrowinning aluminum in a cell as defined in claim 21 or 22, which method comprises passing an electrolysis current from the cathode to the anode through the molten electrolyte to electrolyse the dissolved alumina whereby aluminum is produced on the cathode and oxygen is evolved on the anode, the ceramic barrier layer inhibiting oxidation of said substrate by the evolved oxygen.

24. A cell for the electrowinning of aluminum from alumina dissolved in a molten electrolyte, which cell comprises: an anode; and at least one component as defined in claim 16 or 17 which is a cathode and which has an aluminum-wettable surface.

25. The cell of claim 22, comprising a component as defined in any one of claims 10 to 15 which is an anode.

26. A method of electrowinning aluminum in a cell as defined in claim 24 or 25, which method comprises passing an electrolysis current from the cathode to the anode through the molten electrolyte to electrolyse the dissolved alumina whereby aluminum is produced on the cathode and gas is evolved on the anode, the aluminum-wettable surface being wetted by aluminum.

27. An arc furnace comprising at least one component as defined in claim 19, which component has an inactive surface that is aluminum-wetted.

28. A method of operating the arc furnace of claim 27, said at least one component being an arc electrode, the method comprising passing an electric current through the arc electrode, the aluminum-wetted surface protecting the arc electrode's inactive surface against oxidation.

29. An apparatus for treating molten aluminum comprising at least one component as defined in claim 20, said component being a stirrer, a pipe or a vessel.

30. A method of operating an apparatus as defined in claim 29, said component being a stirrer, a pipe, or a vessel, said method comprising when the component is a stirrer, a pipe or a vessel, respectively: stirring molten aluminum with the component; supplying a treating agent to molten aluminum through the component; or confining molten aluminum in the component.

31. A method of producing a ceramic material comprising the steps of:
providing a structural mass that has an open microporosity and that is made of a refractory compound selected from borides, aluminides and oxycompounds, and combinations thereof; and
impregnating the open microporosity with colloidal and/or polymeric particles of iron oxide and/or a heat-convertible precursor thereof.

32. The method of claim 31, wherein the colloidal and/or polymeric particles are sintered in the open microporosity of the structural mass by a heat treatment.

33. The method of claim 31 or 32, wherein the structural mass is formed by sintering a ceramic particulate.

34. The method of claim 33, wherein the ceramic particulate is suspended in a slurry which is dried before sintering.

35. The method of claim 34, wherein the slurry comprises a colloid and/or a polymer.

36. The method of claim 35, wherein the slurry comprises: colloidal particles selected from lithia, beryllium oxide, magnesia, alumina, silica, titania, vanadium oxide, chromium oxide, manganese oxide, iron oxide, gallium oxide, yttria, zirconia, niobium oxide, molybdenum oxide, ruthenia, indium oxide, tin oxide, tantalum oxide, tungsten oxide, thallium oxide, ceria, hafnia and thoria, and precursors thereof, all in the form of colloids; and/or polymeric particles selected from lithia, beryllium oxide, alumina, silica, titania, chromium oxide, iron oxide, nickel oxide, gallium oxide, zirconia, niobium oxide, ruthenia, indium oxide, tin oxide, hafnia, tantalum oxide, ceria and thoria, and precursors thereof, all in the form of polymers.

37. The method of any one of claims 34 to 36, wherein the slurry comprises at least one organic compound selected from ethylene glycol, hexanol, polyvinyl alcohol, polyvinyl acetate, polyacrylic acid, hydroxy propyl methyl cellulose and ammonium polymethacrylate and mixtures thereof.

38. A ceramic material comprising a structural mass made of a refractory compound selected from borides, aluminides and oxycompounds, and combinations thereof, said structural mass having an open microporosity that is impregnated with colloidal and/or polymeric particles of iron oxide and/or a precursor of iron oxide.

39. The ceramic material of claim 38, wherein the colloidal and/or polymeric particles are present in the open microporosity with or without sintering and constitute an agent to promote wetting of the structural mass by molten aluminum.

40. The ceramic material of claim 36, wherein the colloidal and/or polymeric particles are sintered in the open microporosity of the structural mass to form a sintered barrier against oxygen diffusion through the structural mass.

41. A method of providing an aluminum-wettable component, comprising forming a surface of the component with a ceramic material as defined in claim 38 before exposure of the component to molten aluminum.

42. A method of protecting a substrate against oxidation, comprising covering the substrate with a ceramic material as defined in claim 40 and sintering said colloidal and/or polymeric particles in the open microporosity of said structural mass to form a sintered barrier against oxygen diffusion through the structural mass.
